(19) United States
(12) Patent Application Publication
(10) Pub. No.: US 2024/0083565 A1
(43) Pub. Date: Mar. 14, 2024

(54) Series Addition Aerofoil Launching System

(71) Applicant: BLUEWATER ENGINEERING LIMITED, Stockton-on-Tees (GB)

(72) Inventor: James Ian McGarley, Cumbria (GB)

(21) Appl. No.: 18/272,713

(22) PCT Filed: Jan. 11, 2022
(86) PCT No.: PCT/GB2022/000001

§ 371 Date: Jul. 17, 2023

(30) Foreign Application Priority Data
Jan. 18, 2021 (GB) 2100618.4

(51) Int. Cl. B63H 9/072; B63H 9/08

(52) U.S. Cl. CPC B63H 9/072; B63H 9/08

(57) ABSTRACT

The drag sail has multiple ropes (2) for attaching to a ship (3). A profiled plastic structure in wave form or zigzag is formed by transverse ribs (4). The transverse ribs run together transverse to the wind direction at a distance and exhibit any form e.g. circular, semicircular or square, in shape. The transverse ribs receive the ropes at its end points, and additional ropes (2A) in a middle region. The drag sail is made of plastic or cloth.

### CROSS-REFERENCE TO RELATED APPLICATIONS

This application is the United States national phase of International Application No. PCT/GB2022/000001 filed Jan. 11, 2022, and claims priority to United Kingdom Patent Application No. 2100618.4 filed Jan. 18, 2021, the disclosures of which are hereby incorporated by reference in their entireties.

### BACKGROUND OF THE INVENTION

### Field of the Invention

The use of wind power in propulsion of watercraft has been subject to some innovation over recent years. In particular, tethered aerofoils, sometimes known generically as kites, have taken the place of conventional sails in a number of designs; this specification relates to technology intended to controllably deploy such tethered aerofoils in an array, as and when required.

### Description of Related Art

The use of tethered aerofoils for propulsion has been proven in various forms, from the sport of kitesurfing to systems for assistive propulsion of merchant ships or private yachts. However, the power capacity of tethered aerofoil systems has been limited by the amount of foil area that can practically be deployed, particularly in the latter cases. In kitesurfing the power available is often more than adequate; however, for propulsion of larger craft which suffer higher drag forces, much more power is required. The physical size of very large aerofoils makes for difficult handling, but the use of multiple aerofoils in parallel presents a severe risk of entanglement that could give rise to an emergency situation.

One solution is to deploy aerofoils together in a connected array such that they are arranged in series with one another rather than in parallel, so that they and their tethers are less likely to become entangled with each other, because they are less able to move independently of each other. The difficulty with this solution is that launching and recovering a pre-connected or pre-arranged array requires handling multiple aerofoils at once, and requires either that they all be launched as a complete array or that some intermediate part of the array be secured to the base if no more than a subset of the aerofoils are required to be launched. Launch and recovery in this case may be challenging. This system is also limited in that the configuration of the array is inflexible; the aerofoils are pre-installed in a particular order that cannot be changed, nor can their distribution and spacing.

Various forms of series or branched aerofoil arrays have been proposed in the prior art but none address the problem of reconfiguration of the array while it is airborne. Furling and unfurling systems have been described, in proposed branched arrays, that would allow effective changes in the nature of the array by opening and closing specific aerofoils at will, but this does not amount to truly flexible reconfiguration and branched arrays are still susceptible to entanglement. Where series arrays are described there is no described means of varying the configuration of the array without making fundamental changes to it while it is out of service. Nor is there any described means of varying the position or spacing of foils relative to each other. Moreover, and very importantly, there is no described means of retracting an aerofoil from the series without retracting the entire array. That is unsatisfactory because it would require a significant supply of power to do so in the case of an array with large aggregate aerofoil area, even with the foils adjusted to a minimum practicable coefficient of lift.

### SUMMARY OF THE INVENTION

This invention proposes to improve upon the use of aerofoils for propulsion by providing a means to deploy and retract aerofoils independently as part of a series array, adding and subtracting them from the primary structure of the array.

The basic principle of the system is that an ‘auxiliary aerofoil’ or kite, or group thereof, would first be launched, in order to establish this primary structure by pulling one or more ‘primary tethers’ into the air and tensioning them against the reaction of the base to which they are directly or indirectly connected, such that subsequent ‘duty aerofoils,’ which may be larger and more powerful, can be controllably launched using these primary tethers for guidance, traction, security, reaction or restraint or for any or all of these purposes. This is achieved using runners that can be run out along those primary tethers to a required position and that may be used to connect the duty aerofoils to the primary tethers.

In this specification the following definitions shall be taken to apply:
‘tethered aerofoil’ shall be taken to mean an aerofoil whose physical restraint relies upon tethers, of which there may be one or more;
‘tether’ shall be taken to mean any flexible tension-bearing element;
‘series array’ shall be taken to mean an arrangement where some aerofoils are secured at intervals, regular or otherwise, along a common element, such as a tether or a set of tethers; ‘primary tether’ shall be taken to mean a tether that is connected to at least one auxiliary aerofoil and is directly or indirectly connected to a base such that it may exert pulling forces upon that base;
‘auxiliary aerofoil’ shall be taken to mean an aerofoil that is used to pull a primary tether or set of primary tethers into the air and tension it against the reaction of the base to which it is directly or indirectly connected;
‘duty aerofoil’ shall be taken to mean an aerofoil that may be connected directly or indirectly to the primary tethers such that it may transmit force to them, that is not an auxiliary aerofoil;
‘runner’ shall be taken to mean a device that can travel along a primary tether and to which a duty aerofoil may be directly or indirectly connected.

Runners would preferably be connected to the primary tethers as part of the launch process and may be able to be disconnected when not in use, but alternatively they may reside on the primary tethers such that duty aerofoils may be connected to them prior to launch. The duty aerofoils may be connected to the runners directly or indirectly. When the runners are connected to the primary tethers, they are limited in radial motion relative to those tethers.

The runners may be used to deploy duty aerofoils by a number of methods: by towing the aerofoils as the runners progress outward along the primary tethers; by hauling the aerofoils towards them from an elevated position; by restraining the aerofoils from below as they self-deploy using lift generated from the incident airflow or are hauled away by separate launching kites, or by any other method that uses the runners and uses the primary tethers for guidance, traction, security, reaction or restraint or for any or all of these purposes. A duty aerofoil may be connected to one or more runners on any given primary tether. Two is a preferable solution, one to launch and one to restrain, but more may be necessary, for example if the aggregated power of several were needed.

The system comprises means to cause the runners to move outbound along the primary tethers, means to stop them at a required position and means to cause them to move inbound. These functions may be achieved by various methods, for example: direct engagement between the runners and primary tethers such that they may use them for powered traction, actuated braking or such like; external means such as separate secondary tethers, or independent means such as wind powered runner propulsion systems or thrust sources. The runners may have a localised energy source to enable control, communications and possibly propulsion, or may be supplied with power from the operating base or from elsewhere.

Once a duty aerofoil is deployed onto the array, it may be secured and restrained in its array position by the runners directly, or by separate attachment devices which are actuated to secure the duty aerofoil to the primary tethers. This latter option may allow the runners to be released in order to travel elsewhere along the primary tethers. Whichever method is used, the restraint positions may be set at predetermined points, perhaps by provision of pre-installed fixture points on the primary tethers, or may be continuously variable along the available length of the primary tethers, for example by clamping onto the tethers directly. Continuously variable positioning is preferable because it adds even more versatility to the array and allows the primary tethers to be free of installed parts, making those tethers stronger and their handling easier.

Such a system allows freedom of choice of the size and type of aerofoils to add to the array at a given moment, freedom to choose the order in which to add aerofoils to the array and freedom to choose their position on the array structure, i.e. the interval between one and the next. This level of flexibility allows the operator to purposefully configure the array, perhaps to suit current conditions or imminent operational intentions, without taking the array out of service. The system also allows a duty aerofoil to be retracted without necessitating the retraction of the whole array simultaneously, which is extremely important in minimising the operating power demands of a large, powerful array.

It is observed that although this specification describes a system for aerofoils and kites, it may equally apply to the use of hydrofoils in water and may be alternatively interpreted as such, where the working medium is water in place of air and the foils may be deployed below, on or above the horizontal.

Communications within the system described herein would preferably use radio frequency methods, for example digital UHF communications, but may use wiring, optical, sonic or other methods.

### BRIEF DESCRIPTION OF THE DRAWINGS

The invention will now be described solely by way of example and with reference to the accompanying drawings, which can be captioned as follows:

FIG. 1 shows an outline of the key components of the system.

FIGS. 2a and 2b show a preferred embodiment of the system in which the runners are self-propelled.

FIG. 3 shows a preferred development of the system in which the runners act as carriers of independent attachment devices that secure the duty aerofoils to the primary tethers.

FIGS. 4a and 4b show a non-preferred embodiment in which the runners are free to run along the primary tethers but for being restrained and/or controlled by secondary tethers.

FIG. 5 shows a non-preferred embodiment in which the runners are propelled by dedicated ‘service kites’ which are controlled to make use of the incident airflow to pull the runners along.

FIGS. 6a, 6b and 6c show various means of deploying the duty aerofoils using the runners, including towing, hauling and surging.

### DESCRIPTION OF THE INVENTION

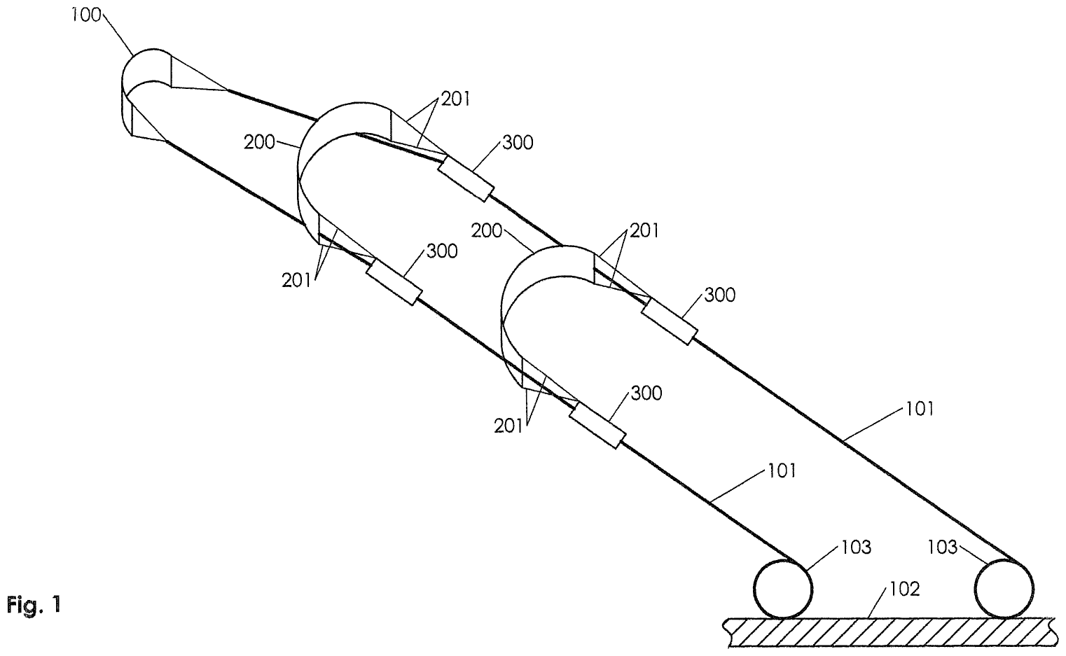

In FIG. 1, an outline sketch of the system is shown. An auxiliary aerofoil 100 holds the primary tethers 101 in the air, tensioning them against the reaction of the base 102. Two primary tethers are shown, which is the preferred solution, but there may be any number. There may also be multiple auxiliary aerofoils, although only one is shown. The primary tethers 101 may be restrained at the base 102 using winches 103 and/or some other means of restraint. Duty aerofoils 200 are restrained to the primary tethers 101 using duty tethers 201 and runners 300, through which they transmit their pull force to the primary tethers and thence to the base, directly or indirectly. Four duty tethers are shown here for each aerofoil, for simplicity, although there may be any number and they may be arranged in a sub-dividing bridle system similar to those used for paragliders or kitesurfing kites.

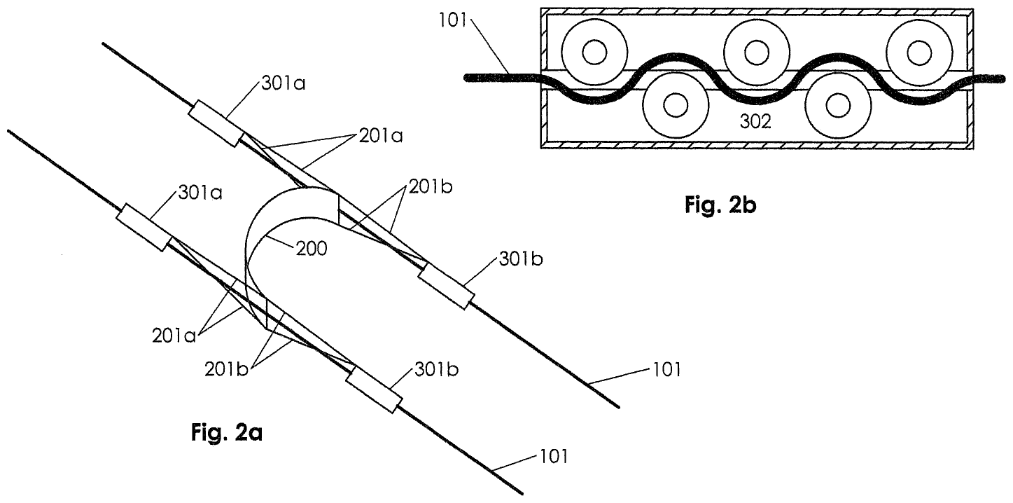

Preferably, this system would use self-propelled runners, which would engage the primary tethers and drive along them to the desired positions. As illustrated in FIG. 2a, a duty aerofoil 200 would be connected to these self-propelled runners 301 by duty tethers 201 which would enable the runners to pull the aerofoil into flight, and would restrain it relative to the primary tethers 101 so that once it fills in the airflow, the lift generated by the aerofoil would be transmitted to the primary tethers. The system may use separate upper and lower runners, whereby the upper runners 301a pull the aerofoil into flight using duty tethers 201a, and the lower runners 301b restrain it relative to the primary tethers using duty tethers 201b. The self-propelled runners may use various drive systems that use the primary tethers 101 for traction, for example a serpentine winch 302 as shown in FIG. 2b, which is preferred; a spiral winch; tether-gripping opposed drive wheels or a reciprocating, ‘walking’ clamp drive mechanism. Alternatively they may use aerodynamic forces or thrust for propulsion, for example using a rocket, jet, fan or propeller. In a variant of the self-propelled embodiment, a runner may be pushed, pulled or manoeuvred by another runner.

In some cases an upper runner may not be required on every primary tether, for example if there were four primary tethers, upper runners may be used only on two of them. There may also be more than one upper runner and/or lower runner on a primary tether, for example if the aggregate power of several were needed.

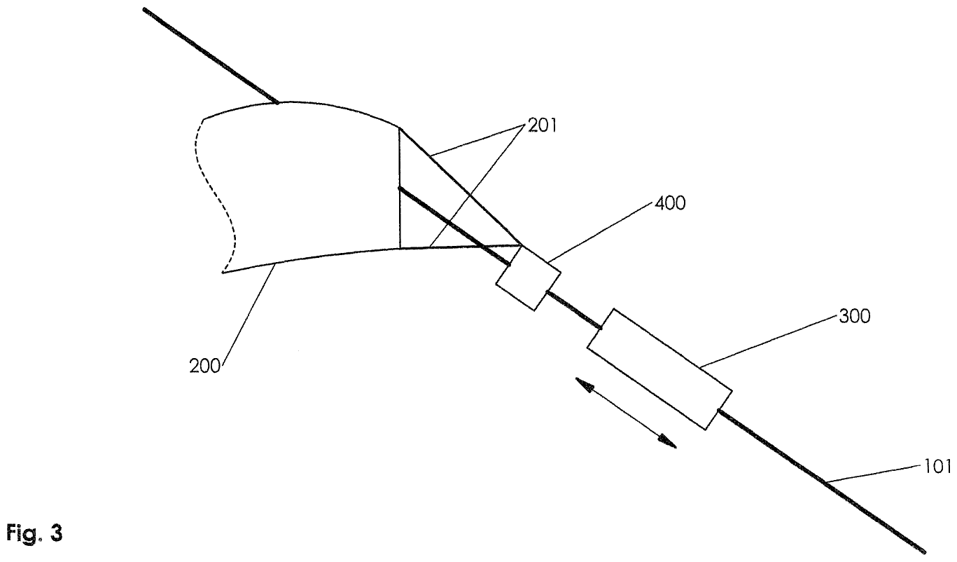

FIG. 3 shows a preferred development of the system whereby a runner 300 transfers an attachment device 400 to a desired position on a primary tether, at which point the device secures itself to the primary tether 101 and the runner releases it. The duty aerofoil 200 would be connected to the attachment device 400 using duty tethers 201, of which there may be several, and thus would be secured by it to the primary tether 101 until the runner 300 returns to retrieve it later. The runner in this case would preferably be self-propelled as described above but may nonetheless be propelled in alternative ways.

An attachment device 400 may be powered from the operating base station or from elsewhere, for example by an electrical cable, or may, preferably, have a localised power source of its own. Power may be necessary to actuate controls that alter the shape or attitude of the duty aerofoil, for example by manipulating the duty tethers 201, and may also be necessary to communicate and receive commands and to carry out other necessary functions, for example data gathering, computation, and lighting. Localised energy reserves may be sufficient for the duration of the operation or may be able to be replenished by a runner or similar device, which could be called a ‘shuttle,’ capable of progressing along the primary tether to reach the attachment device and recharging, refuelling or re-energising it. In this case runners and shuttles may also have their own power sources and energy reserves or may be powered from elsewhere.

In embodiments that do not employ attachment devices, and that rely on the runners to restrain the duty aerofoils relative to the primary tethers, the runners may perform all of the functions attributed to the attachment devices 400 as described herein, and may be supplied with power in the same ways as described for those devices, including the replenishment of their energy reserves by other runners or by shuttles.

An alternative to replenishing the energy reserves of the attachment devices while they are in service is to replace a discharged attachment device 400 with a replacement. The discharged device may then return to the operating base or to a remote energy source to be refuelled, recharged or re-energised. This principle may also be applied to some sub-assembly of the attachment device, for example a removable battery or tank or some form of modular power unit.

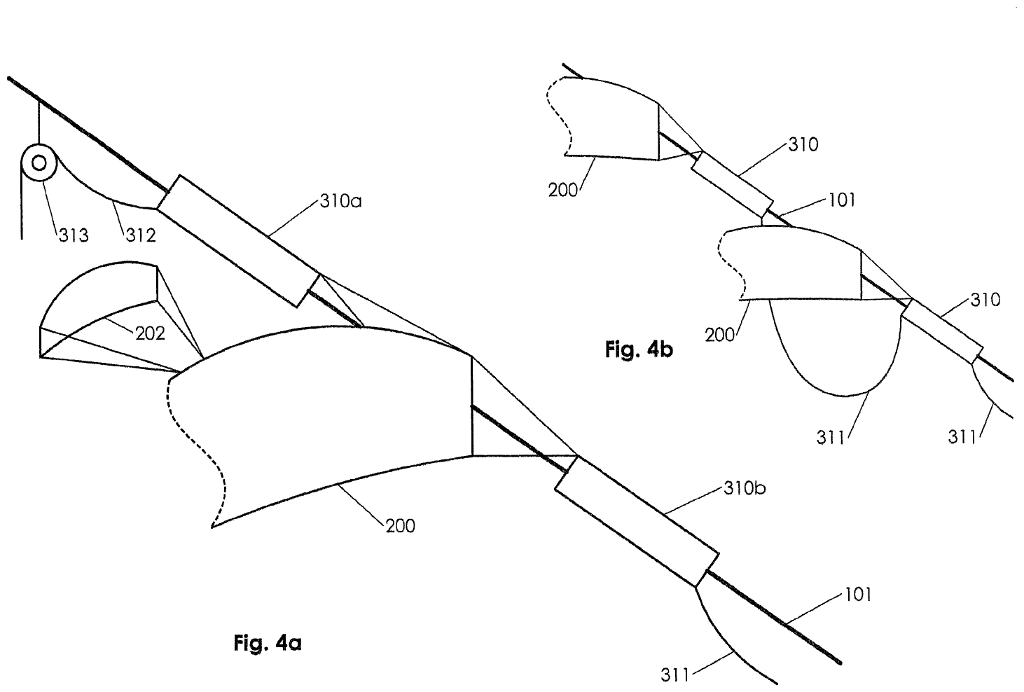

In FIG. 4a, a non-preferred embodiment can be seen where simple runners 310b are controlled by separate, secondary, tethers 311. These tethers would be used to restrain the runners 301b as the duty aerofoils 200 are launched. A duty aerofoil may launch into the airflow under its own lift power, or pulled by a launching kite 202; alternatively it may be pulled into the air by upper runners 310a which are pulled skyward by hoisting tethers 312. These may be hauled up by a mechanism above or turned through a pulley 313 above back down to the operating base from which they are hauled in. The great disadvantage of the hoisting tether system is the multiplicity of tethers that become airborne in parallel as more and more duty aerofoils are launched, much increasing the risk of entanglement, twisting and chafe. Using wind-powered launch and only the secondary, restraining, tethers 311 and single runners 310, as shown in FIG. 4b, these risks can be reduced by use of a clamping mechanism that secures the runners 310 to the primary tethers 101, allowing the secondary tethers 311 to be slackened and their lower ends attached to the following duty aerofoil's runners, forming a slack loop between the aerofoils as they launch, rather than having many secondary tethers all leading in parallel back to the operating base. This does not negate the risk completely, however; a slack loop can also cause problems if left hanging in a breeze.

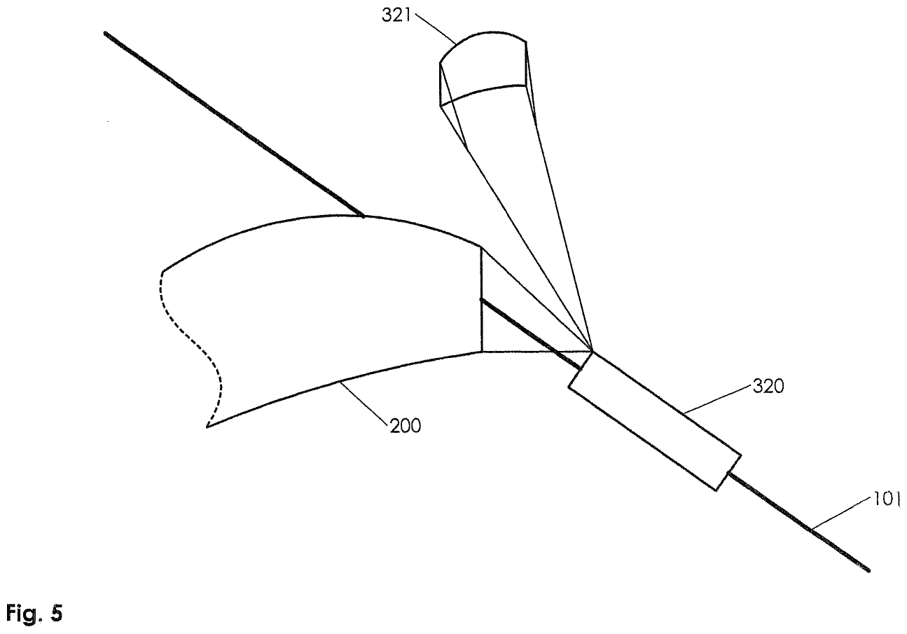

FIG. 5 shows wind-propelled runners 320 which are manoeuvred by controlling the airflow over the ‘service kites’ 321 which propel them. It is not a preferred embodiment of the system, again because of the entanglement risk, but it is a novel, possibly useful means of runner propulsion because very little power input is required to operate it—the majority of the tractive force comes from the wind flowing over the service kites. Some form of clamp mechanism or brake would be needed here, to secure the runners 320 in the desired position along the primary tethers 101.

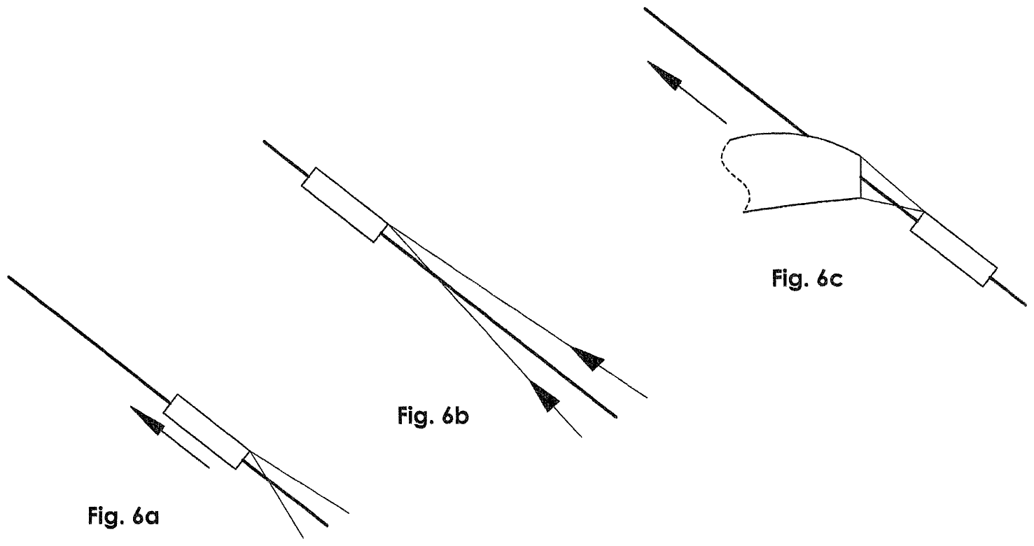

FIGS. 6a, 6b and 6c show several different means of using the runners to launch, position and restrain aerofoils. These include towing as shown in FIG. 6a, hauling from an elevated position as shown in FIG. 6b and restraining from below as shown in FIG. 6c, as the aerofoil launches, surging along the primary tethers, preferably at a controlled rate, and eventually coming to a halt at the required position. A variant of this could be that the runner would come to a halt at a desired position on its primary tether by means of a mechanism which engages with a fitting or mechanism at a predefined point upon the primary tether, or which clamps onto the primary tether after a measured time or distance, or upon remote command.

1. A system for deploying multiple tethered aerofoils to form a series array,
the system comprising:
a primary tether or set of primary tethers;
at least one auxiliary;
one or more duty aerofoils;
runners; and
means of connection between the duty aerofoils and the runners
wherein:
the duty aerofoils are added to the array by connecting the duty aerofoils to the primary tether or tethers using runners, such that the aerofoils can be raised into the air using the primary tether or tethers for guidance, traction, security, reaction or restraint or for any or all of these purposes;
the runners' connections to the primary tethers are such that their radial motion relative to the primary tethers is limited; and
the system comprises:
means to cause runners to travel outbound along the primary tethers;
means to stop runners at one or more required positions;
means to cause runners to travel inbound; and
means to transmit pulling forces from a duty aerofoil to the primary tethers, and
the duty aerofoils' connections to the array are temporary, such that they can be disconnected from the array.

2. The system as described in claim 1, wherein duty aerofoils can be recovered from the air singularly, without necessitating the retraction of other aerofoils in the array.

3. The system as described in claim 1, wherein duty aerofoils can be added to the array in any desired order, to allow choice of, for example, size or type of aerofoil.

4. The system as described in claim 1, wherein the duty aerofoils can be secured to the primary tethers at predefined positions.

5. The system as described in claim 1, wherein the duty aerofoils can be secured to the primary tethers at any position along their length.

6. The system as described in claim 1, wherein the runners can be connected to, and disconnected from, the primary tethers.

7. The system as described in claim 1, wherein the system further comprises a mechanism which slows, stops, actuates or otherwise controls the motion of the runners along the tethers.

8. The system as described in claim 1, wherein runners tow the duty aerofoils into the air.

9. The system as described in claim 1, wherein runners travel outbound along the primary tethers to a position from which they haul duty aerofoils into the air.

10. The system as described in claim 1, wherein runners restrain a duty aerofoil as it launches into the air under its own power or pulled by a launching kite, surging, maybe at a controlled rate, along the primary tethers and coming to a halt at the required position.

11. The system as described in claim 1, wherein some or all runners are self-propelled.

12. The system as described in claim 1, wherein some or all runners are propelled by means of a drive mechanism that uses the primary tether for traction.

13. The system as described in claim 1, wherein some or all duty aerofoils are launched, positioned or recovered using two or more runners on at least one of the primary tethers, for example an upper runner and a lower runner.

14. The system as described in claim 1, wherein the duty aerofoils are secured to the primary tethers by attachment devices which are separate from the runners.

15. The system as described in claim 1, wherein attachment devices and/or runners have a localised source of energy with which to carry out necessary functions, for example propulsion, aerofoil control, internal control, communications, data gathering, computation and lighting, amongst other things.

16. The system as described in claim 15, wherein localised sources of energy may be replenished, refuelled, recharged, re-energised or replaced, as appropriate, using other devices such as runners or shuttles that can travel along primary tethers, and which may have their own localised sources of energy.

17. The system as described in claim 1, wherein it applies to the use of hydrofoils in place of aerofoils and kites, where the working medium is water in place of air and the foils may be deployed below, on or above the horizontal.

18. A system substantially as described with reference to and as illustrated in the accompanying drawings.
